(19) United States
(12) Patent Application Publication
(10) Pub. No.: US 2014/0366865 A1
(43) Pub. Date: Dec. 18, 2014

(54) Grill riser

(71) Applicant: DAYGIN LLC, Cannon Falls, MN (US)

(72) Inventor: David Haberman, Cannon Falls, MN (US)

(21) Appl. No.: 13/915,774

(22) Filed: Jun. 12, 2013

(51) Int. Cl. A47J 37/07; F24B 1/182

(52) U.S. Cl. CPC A47J 37/0772; F24B 1/182
USPC 126/505

(57) ABSTRACT

A grill riser for preparing foods in an outdoor grill or over an open heating source comprising a first plate for holding cookware; a second plate for supporting the first plate over a heat source; and a scissors element connecting the first plate and the second plate, the scissors element secured to each plate and secured within a space between the first plate and the second plate, and wherein the scissors element comprises a first support and a second support, the supports pivotably connected to one another and pivotably adjustable with respect to one another so as to provide a plurality of varying heights between the plates.

### FIELD OF THE INVENTION

This invention relates to a cooking and baking accessory for use with outdoor cooking and/or heating elements, such as a gas, electric or charcoal grill. More specifically, the device enables use of an outdoor grill to cook foods traditionally limited to indoor oven baking or cooking.

### BACKGROUND

The method of preparing various foods successfully with the use of direct heat, such as with the use of outdoor cooking tools, including a gas and/or charcoal grill or other open flame is limited. The types of foods that can be successfully prepared for consumption by this method are also limited. Cooking with either type of grill is usually reserved for meats and fish, as well as certain vegetables as a direct flame and/or direct radiant heat may cook the food items by heating through and slightly charring (i.e. “grill marking”) the sturdy outside of the food product(s). A problem arises in attempting to bake or cook items not usually prepared by grilling methods and/or foods that require the convection heating of a traditional in-door oven. The present invention is a device that allows one to use an outdoor grill to successfully cook or bake foods usually prepared in an in-door oven, by diverting direct heat around a product and allowing the food to be cooked at a controlled distance from the heat source.

### SUMMARY OF THE INVENTION

This disclosure relates to a device for preparing foods in an outdoor grill or over an open heating source, the device comprising a first plate for holding a cooking or heating container, or other cookware; a second plate for supporting the first plate over a heat source; and a scissors element connecting the first plate and the second plate. The scissors element is secured to each plate and secured within a space between the first plate and the second plate. The scissors element comprises a first support and a second support, the supports pivotably connected to one another and pivotably adjustable with respect to one another so as to provide a plurality of varying heights between the plates.

This disclosure also relates to a method for cooking and/or baking using an outdoor cooking source, the method comprises selecting a desired height over a heat source for cooking; extending a scissors element to the desired height, the scissors element connecting a base plate and a cooking surface plate; inserting a retainer into the scissors element to secure the riser at the desired height; setting the base plate in or on the heat source; and setting cookware with food to be cooked onto the cooking surface plate and leaving the cookware on the surface plate until the contents are heated through.

### DESCRIPTION OF THE DRAWINGS

FIG. 1A is a perspective view of a grill riser in a collapsed position.

FIG. 1B is a perspective view of the grill riser in an extended position.

FIG. 2 is perspective view of the scissors element supports.

FIG. 3 is a top view of the support plate of the grill riser.

FIG. 4 is a top view of the base plate.

### DETAILED DESCRIPTION

A grill riser 10 comprises two heat baffling plates, a base plate 12 for resting in, on or proximate to a heat source or open flame and a support plate 14 for supporting an item, cooking pan, baking sheet, cookware or other container to be heated for cooking the contents and a scissors element 16 connecting the two plates and enabling varying height adjustment between the base plate and the support plate and thus adjusting the height between the heat source and the item or container. The grill riser also comprises a locking pin 18 to secure the scissors element at a selected height.

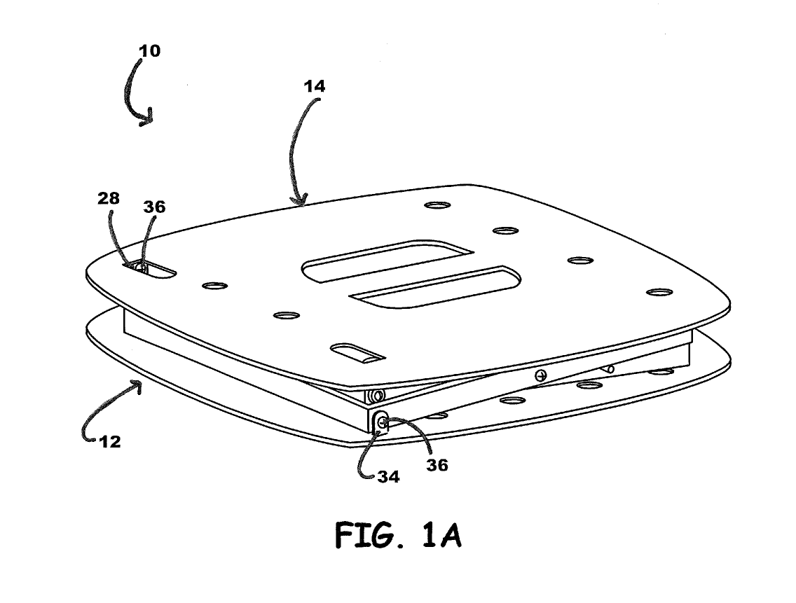

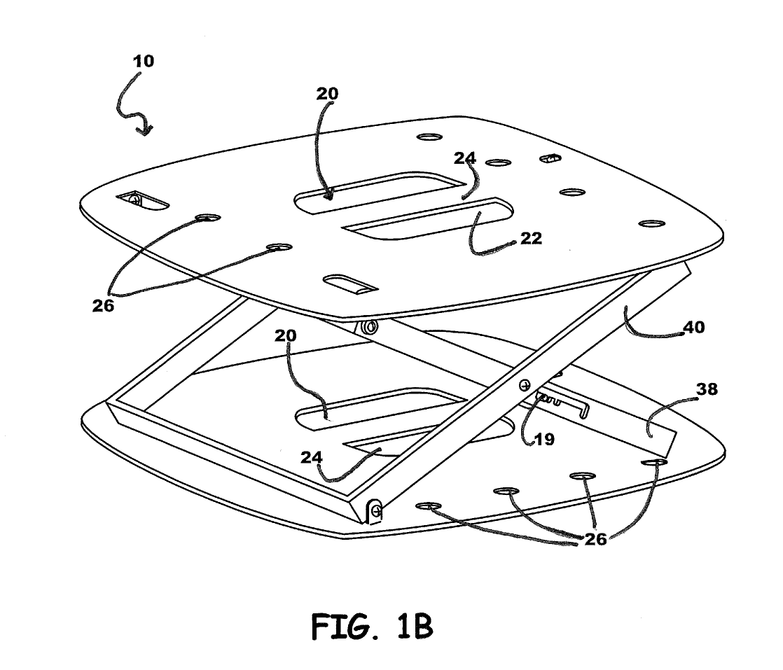

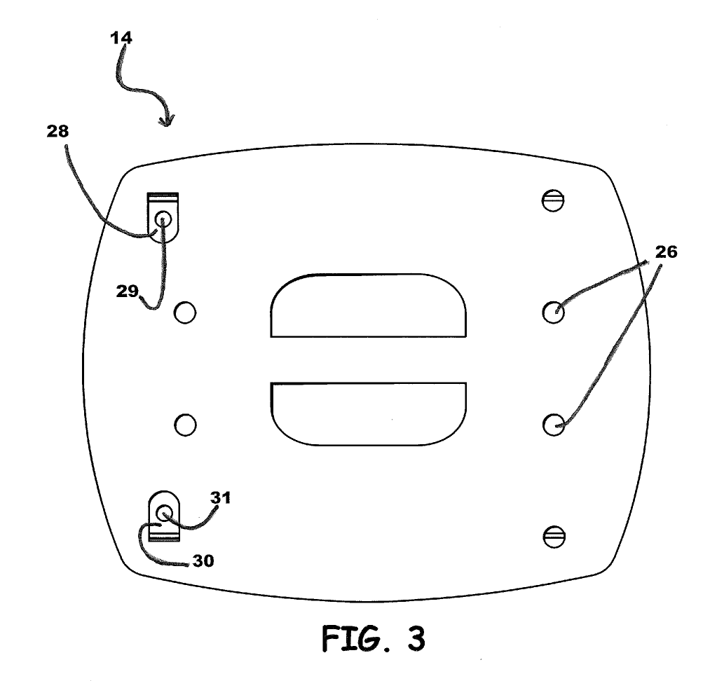

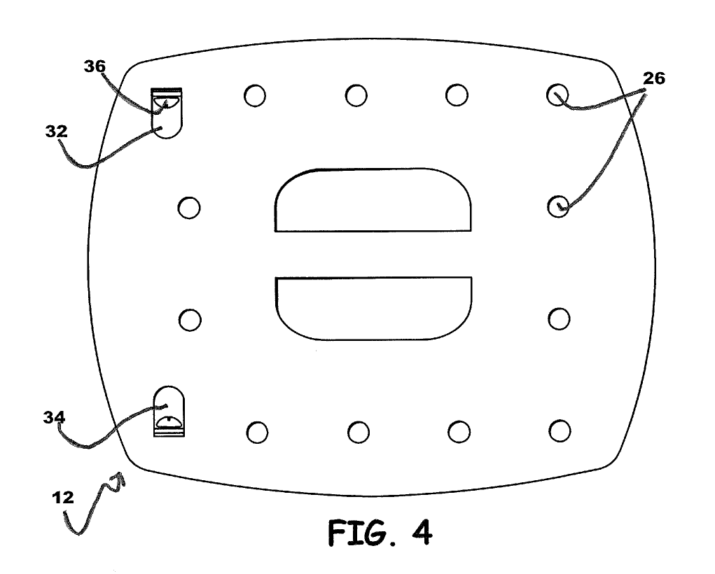

As illustrated generally in FIGS. 1-5, the grill riser 10 comprises a bottom or lower base plate 12 and an upper or top support plate 14. Both the base plate 12 and the support plate 14 are generally rectangular in shape, however the plates may be rounded, square or of any other shape or variation suitable for use a base surface and a support surface. The base plate 12 and the support plate 14 are substantially of the same shape, size and construction. In one embodiment the plates 12 and 14 are approximately 1/16 inch thick, however the thickness can be varied. The plates 12 and 14 can be comprised of any suitable metal including steel, stainless steel, aluminum or any like material that is light-weight, sturdy, durable, and able to withstand high cooking temperatures without deforming.

Each plate 12 and 14 is similarly adapted in the center with two adjacent and parallel identical size apertures 20 and 22, such that an integral handle 24 is formed between the apertures 20 and 22. The apertures 20 and 22 are large enough to allow a user to insert their fingers and/or thumb to wrap around the portion of the plate 12 and 14 between the apertures. The handle 24 can be used when assembling, disassembling, moving or transporting, or cleaning the device. When the device is in use for cooking or heating an item, the apertures 20 and 22 also act to enable heat and air flow from the heat source to flow through the base plate and rise to and through the support plate.

Each plate 12 and 14 is also adapted with a plurality of substantially smaller apertures, or baffle holes 26. The baffle holes 26 are placed to enable controlled air flow and heat flow through the base plate 12 and through the support plate 14. On the base plate 12 and the support plate 14, the baffle holes 26 are spaced apart around the inner portion of the outer perimeter of the plate. On the support plate 14, it is possible to adapt baffle holes on two opposing edges of the plate such that the baffles comprise a stamp, or cut-out in the shape of the name of the product. The shape of the baffles is not limited in this invention, the shape and size of the baffles is dependent on sufficient air flow and heat flow, but the amount and shape of the baffle holes is not so numerous or large in size so as to affect the structural integrity, strength, and ability of the device to support weight.

Two opposing corners on one side of both the base plate 12 and the support plate 14 are adapted with tabs 28, 30, 32 and 34. The plates 12 and 14 are adapted with the tabs 28, 30, 32 and 34 at the corners, such that when the base plate and support plate are stacked, the two corner base plate tabs are aligned with the two corner support plate tabs. Each tab 28, 30, 32 and 34 is adapted with an aperture 29, 31, 33, 35 for connection with a fastener 36. The aperture 29, 31, 33, 35 is approximately centered in the tab 28, 30, 32 and 34.

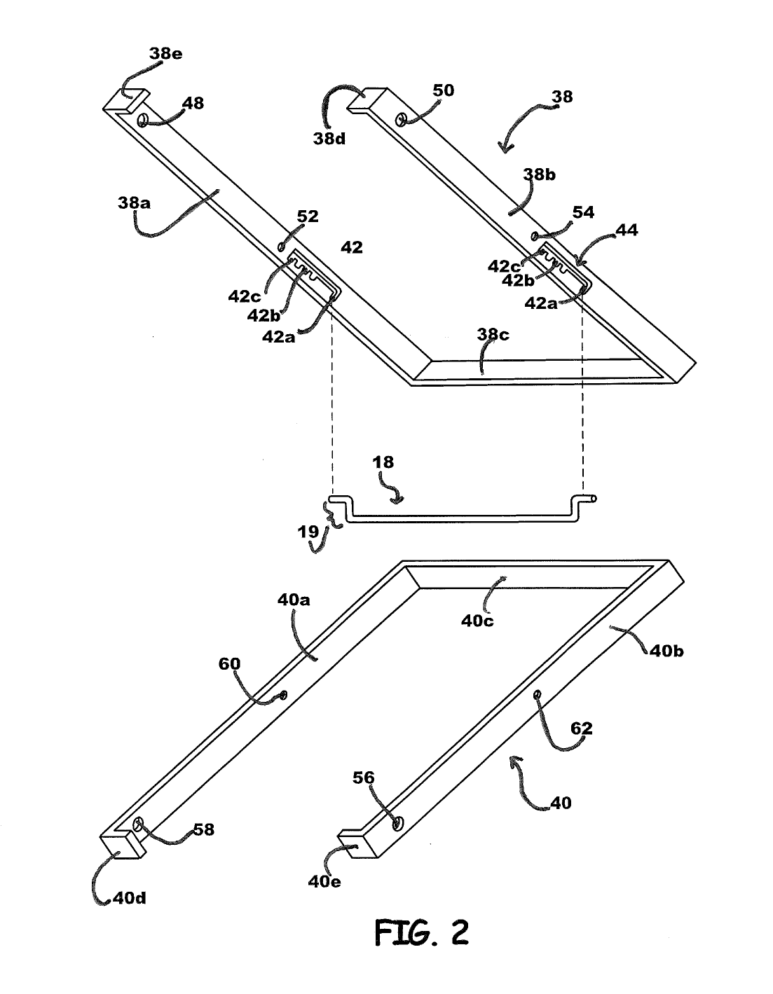

Illustrated generally at FIG. 2, a scissors element 16 is comprised of a first 38 and second 40 flat scissors support. The scissors supports 38 and 40 are comprised of substantially the same material metal as the plates. Each scissors support is comprised of a flat metal strip, approximately ¾ inch wide and approximately 1/16 inch in thickness. The continuous strip is formed into a squared “U” shape, such that a set of opposing sides 38a and 38b and 40a and 40b are connected by an adjacent side 38c and 40c. The “U” is substantially rectangular in that the “U” measures approximately 6″×8″ and such that sides 38a, 38b and 40a and 40b are approximately the same length. A bend connects each opposing side 38a, 38b, 40a, and 40b to the adjacent side 38c or 40c at approximately a 90-degree angle. A terminal end of each opposing side is bent approximately 1″ inward at approximately a 90-degree angle to form a connection support 38d, 38e, 40d and 40e.

The first scissors support 38 is adapted on the two opposing sides 38a and 38b with a cut out 42 and 44 for securing scissors element 16 height positions. The cutouts 42 and 44 on each opposing side 38a and 38b are substantially identical and aligned. Each cut out extends along a portion of the opposing side from approximately the center and of the opposing side to the bend connecting with the adjacent side. The cutout 42 and 44 extends along the side approximately halfway between the center of the side and the bend. The placement of the cut out 42 and 44 allows the scissors element 16 to be secured in the maximum number of heights. The extension of the cut out may be shortened or lengthened, or moved along the length of the side depending on the desired height of extension and the number of secured positions of extension. The cutouts 42 and 44 are approximately rectangular in shape with four downward facing loop cutouts. A first downward loop 42a and 44a is cutout at the distal end of the cutout, and allows the scissors element to be secured in a first extension height, which can be approximately 1 and ½ inches. The second 42b and 44b and third 44d and 44c downward loop cutouts are spaced along the cut-out between the distal and proximate ends of the cutout and allow the scissors element to be secured in a second and a third extension heights, which can be approximately 2½ and 3½ inches respectively. The fourth downward cutout 42d and 44d is positioned adjacent to the proximate end of the cutout and allows the scissors element to be secured in a fourth extension height, which can be approximately 4½ inches.

A locking pin or metal bar 18 is used to secure the scissors element 16 at a desired height. Once extended, the locking pin 18 is placed such that the groove engaging length 19 of the pin 18 rests in the corresponding downward grooves, which prevent the scissors supports from collapsing to a first, base position. The locking pin 18 is a metal rod wherein the proximate end can be adapted with a bend or metal ring (not shown) to form a handgrip. The locking pin 18 is adapted adjacent to the handgrip and the distal end is similarly adapted with a groove engaging length 19 which allows the pin to fit securely into the downward grooves in the each scissors support simultaneously.

The first scissors support 38 is adapted with four apertures 48, 50, 52 and 54 for receiving a fastener 36. Each opposing side 38a and 38b is adapted identically with two apertures 52 and 54. A first aperture 52 and 54 is approximately centered in and along the length of each opposing side 38a and 38b. A second aperture 48 and 50 is located proximate the terminal end of the opposing side 38a and 38b, adjacent to the bend connecting the connection support.

The second scissors support 40 is adapted with four apertures 56, 58, 60 and 62 for receiving a fastener 36. Each opposing side 40a and 40b is adapted identically with two apertures 60 and 62. A first aperture 60 and 62 is approximately centered in and along the length of each opposing side 40a and 40b. A second aperture 56 and 58 is located proximate the terminal end of the opposing side, adjacent to the bend connecting the connection support.

All sides are adapted with apertures such that the center apertures 52 and 60 and 54 and 62 are aligned for connection by a fastener 36. The fastener 36 may be a pan screw and locking nut connection, or any other suitable connection or fastener that enables pivotal movement and that resists loosening under torque.

To assemble the scissors element 16, the first and second scissors supports 38 and 40 are secured to one another at the center aperture 52 and 60 and 54 and 62. The scissors supports 38 and 40 are aligned such that adjacent sides 38c and 40c are aligned and the opposing side 38b and 40a and 38a and 40b of each support 38 and 40 are aligned and facing the same direction. The opposing sides 38a and 38b of the first scissors support 38 are connected inside the opposing side 40a and 40b of the second scissors support 40, such that an outer face of each opposing side of the first scissors support is in contact with an inner side of each opposing side of the second scissors support. The supports 38 and 40 are secured together by inserting the fastener 36 into aperture 60 and through aperture 52 and securing the fastener and inserting another fastener 36 into aperture 62 and through aperture 54 and securing the fastener. This connection is a pivotal connection, allowing the scissors supports 38 and 40 to pivot about the apertures and pivot with respect to one another.

The tabs 28 and 30 of the support plate 14 are folded in and downward from an inside face of the support plate 14. The first scissors support 38 is secured to the support 14 plate by aligning the terminal end apertures 48 and 50 with the apertures 29 and 31 in the tabs 28 and 30. The tabs 28 and 30 are secured outside the riser support 38, such that an inner surface of the tab is in contact with the outer surface of the opposing side length. The fastener 36 is inserted through both apertures and secured. The connection is a pivotal connection, allowing the scissors element 16 to pivot about a horizontal axis of the fastener.

The tabs 32 and 34 of the base plate 12 are folded in and upward from an inside face of the base plate 12. The second scissors support 40 is secured to the base plate 12 by aligning the terminal end apertures 58 and 56 with the apertures 33 and 35 in the tabs 32 and 34. The tabs 32 and 34 are secured outside the second scissors support 40, such that an inner surface of the tab is in contact with the outer surface of the opposing side length. The fastener 36 is inserted through both apertures and secured. The connection is a pivotal connection, allowing the scissors element to pivot about a horizontal axis of the fastener.

When the scissors element 16 is assembled and in a collapsed position for storage, transport, or cooking close to a heat source, the scissors element 16 is unextended and collapsed completely within the base and support plates 12 and 14.

The grill riser 10 as disclosed above is assembled with four pivotal connections; the connections of the scissors supports to one another, the pivotal connection of the scissors support to the base plate and the pivotal connection of the scissors support to the support plate. The pivotal connections at the plates 12 and 14 are disposed on the same side of the grill riser 10 when assembled. The pivotal connection allows the base 12 and support plate 14 to open such that the only contact of the scissors supports and the base or support plate is at the pivotal connection. This open position allows a user to easily secure the scissors element in any extended position by inserting the pin into the aperture for locking. This open position also allows a user to easily clean or wipe off the grill riser. Further, a user may extend the scissors supports and retain them in a desired position and still be able to pivot the base plate and/or the support plate freely without affecting the scissors element.

When the support plate 14 and base plate 12 are opened or pulled away from one another, the adjacent sides of the scissors supports slide along the base plate and the support plate respectively allowing the scissors supports to extend or collapse. This can be done manually or by gravity in simply picking up an end and allowing the scissors supports to slide. The locking pin 18 is then placed in the corresponding downward loop in each cutout for the desired height extension. The pin 18 will prevent movement of the second scissors support 40 and will retain both scissors supports 38 and 40 in a desired position. The riser supports are then retained substantially in an “X” or scissors crossed configuration, which supports the base plate 12 and the support plate 14. The support plate 14 and base plate 12 are then supported by the pivotal connections wherein the opposing end of the pivot connection is in contact with the opposing side of the opposite plate. The adjacent ends support the plates on the sides opposite the pivotal connections.

The locking pin 18 extends across the grill riser from one side edge cutout 42 to the other 44. Other means of securing the plate in an extended phase can be used, including multiple smaller pins for interaction with the downward grooves.

When the base plate is placed directly on or over a heat source from a grill or other open flame, a food container or a food packaging is directly placed on the support plate and is additionally extended from the heat source relative to the extended position of the scissors element selected by the user. The level of extension is dependent on cooking time, type of food, and type of container used. The food is then cooked from the bottom by the heating of the support plate, and is cooked by the heat from the heat source wherein the heat is allowed to flow through the baffle holes in each plate and disperse around the device and the support surface.

The base plate and support plate may also be adapted on the open side with a hook and loop or other fastener 50 which can be connected or secured during transport or storage, or used in the unextended position to retain the grill riser in the collapsed position.

Although the present invention has been described with reference to preferred embodiments, workers skilled in the art will recognize that changes may be made in form and detail without departing from the spirit and scope of the invention.

What is claimed:

1. A device for preparing foods in an outdoor grill or over an open heating source the device comprising:
a first plate for holding cookware;
a second plate for supporting the first plate over a heat source; and
a scissors element connecting the first plate and the second plate, the scissors element secured to each plate and secured within a space between the first plate and the second plate, and wherein the scissors element comprises a first support and a second support, the supports pivotably connected to one another and pivotably adjustable with respect to one another so as to provide a plurality of varying heights between the plates.

2. The device of claim 1 wherein the first plate and the second plate are adapted with a plurality of apertures, the apertures allowing air and heat to flow through the plates and around the device.

3. The device of claim 2 wherein two of the plurality of apertures in the first plate are adapted to form a handle.

3. The device of claim 2 wherein each plate comprises a heat conducting metal.

4. The device of claim 1 wherein the first support is secured to a single edge of the first plate and the second support is secured to a single edge of the second plate such that the device when assembled is secured on a first side and unsecured on a second side.

5. The device of claim 4 wherein a first pair of tabs extends inward from the first plate to connect with the first support and a second pair of tabs extends inward from the second plate to connect with the second support.

6. The device of claim 1 wherein the scissors element is retained at a selected height from the plurality of heights by a locking mechanism.

7. A method for cooking and/or baking using an outdoor cooking source, the method comprising:
selecting a desired height over a heat source for cooking;
extending a scissors element to the desired height, the scissors element connecting a base plate and a cooking surface plate;
inserting a retainer into the scissors element to secure the scissors element at the desired height;
setting the base plate in or on the heat source; and
setting cookware holding food to be cooked onto the cooking surface plate and leaving the cookware on the surface plate until the contents are heated through.

8. The method of claim 8 wherein extending the scissors element comprises displacing a pair of supports about a first pivotal connection and displacing the pair of supports about a second pivotal connection.

9. The method of claim 8 wherein inserting a retainer further comprises the step of inserting the retainer into an aperture in a first support of the pair of supports and retaining the second support of the pair of supports.

10. The method of claim 8 and including the additional step of removing the retainer and collapsing the riser and securing a latch on the cooking surface plate to the base plate.
